(19) United States
(12) Patent Application Publication
(10) Pub. No.: US 2020/0254464 A1
(43) Pub. Date: Aug. 13, 2020

(54) NOZZLE ASSEMBLIES AND A METHOD OF MAKING THE SAME UTILIZING ADDITIVE MANUFACTURING

(71) Applicant: DLHBOWLES, INC., Canton, OH (US)

(72) Inventors: Alan ROMACK, Columbia, MD (US); Zachary KLINE, Burtonsville, MD (US); Russell HESTER, Odenton, MD (US)

(21) Appl. No.: 16/784,990

(22) Filed: Feb. 7, 2020

Related U.S. Application Data
(60) Provisional application No. 62/802,242, filed on Feb. 7, 2019.

(51) Int. Cl. B05B 1/12; B29C 64/112; B29C 64/209; B29C 64/245; B29C 64/264; B29C 64/379

(52) U.S. Cl. CPC B05B 1/12; B29C 64/112; B29C 64/209; B33Y 10/00; B29C 64/264; B29C 64/379; B29C 64/245

(57) ABSTRACT

Provided is a continuous nozzle assembly that includes a fluidic geometry that extends between an inlet and an outlet, wherein a flow of fluid is configured to enter the inlet and process through the fluidic geometry and exit the outlet in a predetermined spray pattern. The continuous nozzle assembly may be made by additive manufacturing methods. In one embodiment, provided is a fluidic oscillator insert that includes a fluidic geometry that is manufactured by additive manufacturing techniques.

### CROSS REFERENCE TO RELATED APPLICATIONS

This applications claims the benefit of and priority to U.S. Provisional Application No. 62/802,242 entitled “NOZZLE ASSEMBLIES AND A METHOD OF MAKING THE SAME UTILIZING ADDITIVE MANUFACTURING” filed on Feb. 7, 2019, which is incorporated by reference in it entirety.

### FIELD OF INVENTION

The present disclosure generally relates to fluidic oscillators and nozzle assemblies and methods of making the same while maintaining a desirable geometric configuration to produce an oscillating flow of fluid therefrom.

### BACKGROUND

For as long as there have been vehicles moving around, there has been a need to clean a surface on them for convenience and safety. For example, on today's automobiles there are windshields, rear glass, headlamps, rear cameras, front cameras and a multitude of additional sensors that do not work as effectively when soiled. These sensors can be located all over the vehicle. For many decades the primary need for cleaning has been limited to windshields, rear glass and headlamps.

### SUMMARY OF THE APPLICATION

Provided is a method of manufacturing a monolithic nozzle device configured to spray a fluid spray having a predetermined flow rate, angle, or pattern. The method comprises depositing, from at least one dispenser head, a layer of material onto a platform having a pattern configured to allow fluid flow through at least one die-locked tortuous fluid passage; adjusting the dispenser head or platform; depositing a plurality of subsequent layers of material onto said prior layers of material on said platform, the resulting layers having a common pattern to allow fluid to flow through said at least one die-locked tortuous fluid passage; adjusting the dispenser head or platform upon each layer until the nozzle device is formed; and curing the nozzle device by applying a light to the plurality of layers to bond the plurality of layers together. Once cured, the nozzle device includes the at least one die-locked tortuous fluid passage positioned between an inlet and an outlet, such that fluid is configured to enter the inlet, pass through the die-locked tortuous fluid passage, and exit the outlet. The die-locked tortuous fluid passage may be configured to modify a pressure profile of the fluid passing therethrough, such that the fluid is configured to exit the outlet having a predetermined flow rate, angle, or pattern. The nozzle device may then be removed from the platform. The die-locked tortuous flow passage may include at least one floor surface, at least one ceiling surface, and a plurality of walls that define an interaction chamber in communication with at least one power nozzle and the outlet. The material may be a three-dimensional printable liquid photo-polymeric material that includes a resolution that is less than 50 microns. The material may include a resolution size based on the size of said nozzle device to be manufactured, including: for a nozzle device that includes a size that is under about 3 inches, the material includes a resolution range that is below about 50 microns; and for a nozzle device that includes a size that is between about 3 inches to about 10 inches, the material includes a resolution range that is greater than about 100 microns and less than 1000 microns. The step of depositing a layer of material onto a platform may further comprise depositing a plurality of layers of material onto the platform to form a plurality of nozzle devices. The step of curing the nozzle includes applying a UV light or laser to the plurality of layers. The die-locked tortuous fluid passage and the outlet may be configured to spray a shear type spray or an oscillating type spray.

In another embodiment, provided is a monolithic nozzle device comprising a nozzle head including an outer surface and a die-locked tortuous fluid passage positioned within the outer surface. The die-locked tortuous fluid passage is shaped to define a fluidic geometry located between an inlet and an outlet of the nozzle head. The fluidic geometry may include a floor surface, a ceiling surface, and a plurality of walls shaped to form the fluidic geometry, wherein the die-locked tortuous fluid passage is configured to modify a pressure profile of a fluid passing therethrough, such that said fluid is configured to exit the outlet having a predetermined flow rate, angle, or pattern. The die-locked tortuous fluid passage may be monolithically formed within the nozzle head. The fluidic geometry may include at least one interaction chamber and at least one power nozzle configured to increase the pressure of a flow of fluid and distribute said flow of fluid to the interaction chamber to be dispensed from the outlet in an oscillating manner. The floor surface, ceiling surface and plurality of walls may define a single cavity that includes aggressive texturing or shapes not formable by injection molding. The fluidic geometry may comprise a dual sided fluidic oscillator geometry that includes: an upper floor surface, a lower floor surface, an upper ceiling surface and a lower ceiling surface; and an upper interaction chamber positioned above a lower interaction chamber, wherein each interaction chamber is in fluid communication with at least one power nozzle and an opposite upper outlet and lower outlet configured to distribute a spray of fluid in an oscillating manner from both upper and lower outlets. The nozzle device may include an angled outlet that is configured to generate a plurality of sprays, wherein the plurality of sprays include three-dimensional converging or diverging patterns. The fluidic geometry may include at least one of hemispherical shear geometry, multi-lip shear geometry, and a plurality of die-locked filter posts. The fluidic geometry may be configured to generate a three-dimensional distribution patterned spray having an X-shaped pattern. The fluidic geometry may be configured to generate a shear type spray or an oscillating type spray from the outlet.

In yet another embodiment, provided is a method of manufacturing a plurality of monolithic nozzle devices, each configured to spray a fluid spray having a predetermined flow rate, angle, or pattern. The method comprises depositing, from a plurality of dispenser heads, a plurality of layers of material onto a platform, each having a pattern configured to allow fluid flow through at least one die-locked tortuous fluid passage; adjusting the plurality of dispenser heads or platform; depositing subsequent layers of material onto said platform having a continuous pattern with the prior layers of material to allow fluid to flow through said at least one die-locked tortuous fluid passage and adjusting the plurality of dispenser heads or platform upon each layer until the nozzle device is formed; and curing the nozzle device by applying a light to each of the plurality of layers to bond the plurality of layers together. Once cured, each of the plurality of nozzle devices include the at least one die-locked tortuous fluid passage positioned between an inlet and an outlet, such that fluid is configured to enter the inlet, pass through the die-locked tortuous fluid passage, and exit the outlet. The die-locked tortuous fluid passage of the plurality of nozzle heads may be configured to modify a pressure profile of the fluid passing therethrough, such that the fluid is configured to exit the outlet having a predetermined flow rate, angle, or pattern. The plurality of nozzles may be removed from the platform. The die-locked tortuous flow passage may include at least one floor surface, at least one ceiling surface, and a plurality of walls that define an interaction chamber in communication with at least one power nozzle and the outlet. The material may include a resolution size based on the size of said nozzle device, including: for a nozzle device that includes a size that is under about 3 inches, the material includes a resolution range that is below about 50 microns; and for a nozzle device that includes a size that is between about 3 inches to about 10 inches, the material includes a resolution range that is greater than about 100 microns and less than 1000 microns. The die-locked tortuous fluid passage and the outlet may be configured to spray a shear type spray or an oscillating type spray.

### DESCRIPTIONS OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a front isometric view of a mushroom style fluidic insert illustrating an embodiment of a die-lock tortuous fluid passage pattern contemplated to be used in the monolithic nozzle device of the instant disclosure;

FIG. 2 is a side perspective view of a jet island circuit type fluidic insert illustrating an embodiment of a die-lock tortuous fluid passage pattern contemplated to be used in the monolithic nozzle device of the instant disclosure;

FIG. 3 is an enlarged view of a multi-lip shear nozzle assembly illustrating an embodiment of a die-lock tortuous fluid passage pattern contemplated to be used in the monolithic nozzle device of the instant disclosure;

FIG. 4 is an exploded view of a fluidic nozzle assembly of the prior art;

FIG. 5 is a cross sectional view of an assembled dual sided fluidic nozzle assembly illustrating an embodiment of a die-lock tortuous fluid passage pattern contemplated to be used in the monolithic nozzle device of the instant disclosure;

FIG. 6 is a front view of the assembled dual sided fluidic nozzle assembly of FIG. 5, illustrating an embodiment of die-lock tortuous fluid passage pattern contemplated to be used in the monolithic nozzle device of the instant disclosure;

FIGS. 7A, 7B, and 7C illustrate various views of a large aim enclosure for a fluidic oscillator circuit illustrating an embodiment of a die-lock tortuous fluid passage pattern contemplated to be used in the monolithic nozzle device of the instant disclosure;

FIG. 8A is a cross sectional view of a flip-top fluidic circuit illustrating an embodiment of a die-lock tortuous fluid passage pattern contemplated to be used in the monolithic nozzle device of the instant disclosure;

FIG. 8B is a perspective side view the flip-top fluidic circuit of FIG. 8A;

FIG. 9 is an exploded view of a four piece camera wash nozzle assembly illustrating an embodiment of a die-lock tortuous fluid passage pattern contemplated to be used in the monolithic nozzle device of the instant disclosure;

FIG. 10A is an exploded view of an irrigation head nozzle assembly with a plurality of fluidic inserts illustrating an embodiment of a die-lock tortuous fluid passage pattern contemplated to be used in the monolithic nozzle device of the instant disclosure;

FIG. 10B is an assembled perspective view of a irrigation head nozzle assembly with a plurality of fluidic inserts of FIG. 10A;

FIG. 11 is a cross sectional view of a shower head assembly with a plurality of fluidic inserts illustrating an embodiment of a die-lock tortuous fluid passage pattern contemplated to be used in the monolithic nozzle device of the instant disclosure;

FIG. 12 is a perspective view of a body wash assembly with a plurality of fluidic inserts illustrating an embodiment of a die-lock tortuous fluid passage pattern contemplated to be used in the monolithic nozzle device of the instant disclosure;

FIG. 13 is a perspective view of a wall-less fluidic circuit assembly illustrating an embodiment of a die-lock tortuous fluid passage pattern contemplated to be used in the monolithic nozzle device of the instant disclosure;

FIG. 14 is a front view of a-tapered 3D fluidic assembly illustrating an embodiment of a die-lock tortuous fluid passage pattern contemplated to be used in the monolithic nozzle device of the instant disclosure;

FIG. 15 is a side view of the tapered 3D fluidic assembly illustrating an embodiment of a die-lock tortuous fluid passage pattern contemplated to be used in the monolithic nozzle device of the instant disclosure;

FIG. 16 is a perspective view of an embodiment of a nozzle device having a continuous monolithic construction that includes a die-locked tortuous fluid path between an inlet and an outlet according to the instant application;

FIG. 17 is a schematic side view of a method of making a nozzle device having a continuous monolithic construction that includes a die-locked tortuous fluid path between an inlet and an outlet according to the instant application; and

FIG. 18 is a flow chart of embodiments for a method of manufacturing a fluidic oscillator insert or a continuous monolithic nozzle assembly having a die-locked tortuous fluid path according to the instant disclosure.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings. In this disclosure, any identification of specific shapes, materials, techniques, arrangements, etc. are either related to a specific example presented or are merely a general description of such a shape, material, technique, arrangement, etc.

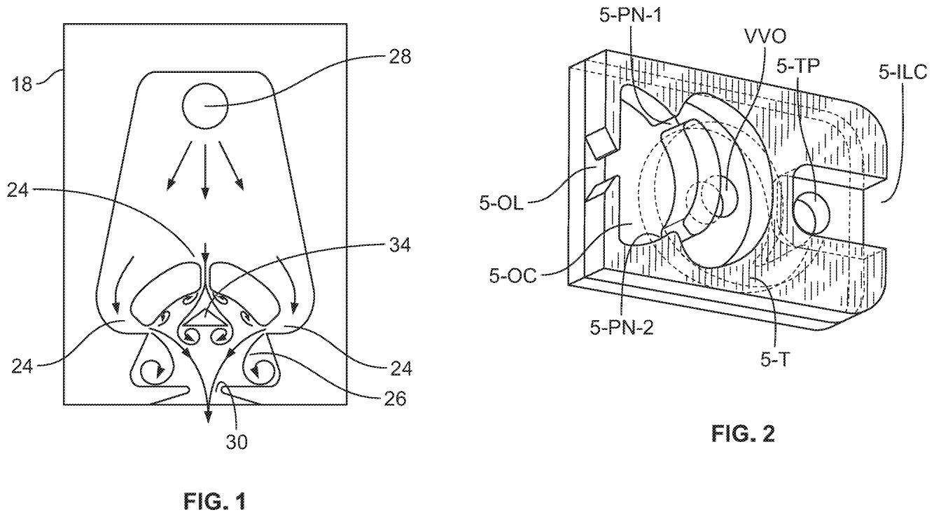

There are several techniques available to make cleaning nozzles that are designed to spray in a desired spray pattern. Simple shut-off shear nozzles can be employed and can be injection molded rather simply, with no trapped or internal steel materials. The performance of these nozzles is basic and does not typically meet the needs of the more modern cleaning requirements established by vehicle manufacturers and governments. Another nozzle style is the so called “bug-eye” or jet nozzle. In this implementation, the nozzle housing is made as one piece and then a small hemispherical metal “eye” is installed into a pocket in the nozzle. This methodology is fairly robust and also does not have trapped steel for injection molding. The performance of these types of nozzles produces a small elliptical patch on the surface to be cleaned and can result in longer cleaning times. Modern expectations for cleaning times require short durations which typically limit this style of nozzle used in today's vehicles. The best nozzle and vehicle performance occurs when an effective distribution of fluid (covering a large trapezoidal surface area typically as long as the wiper blade) is produced on the surface to be cleaned throughout the cleaning cycle. Fluidic nozzles are a popular method of achieving this performance. Due to their more complicated flow path geometry, they must be manufactured in at least two separate pieces so as not to create trapped or die-locked portions in the molded components. “Die-Locked” is a condition in a stamping or molding process where the shape of a part is not accessible to direct action of a stamp or mold. FIG. 1 illustrates one such fluidic circuit, from U.S. Pat. No. 7,651,036, which is incorporated by reference herein in its entirety and includes incomplete three-sided fluid flow paths made by injection molding. FIG. 2 shows a similar but different fluid from U.S. Pat. No. 7,293,722, which is incorporated by reference herein in its entirety in an isometric view to show the three-sided flow paths that are completed once installed in a housing.

U.S. Pat. Nos. 6,497,375, 6,186,409, and 5,749,525 are also incorporated by reference herein in their entireties and show several different methods for producing the fluidic geometry of these kinds of nozzles mentioned previously. Examination of the internal passages shows the directionality of the “pull of the steel” necessary to make such parts. There are many examples of this available, and the ones listed above are exemplary.

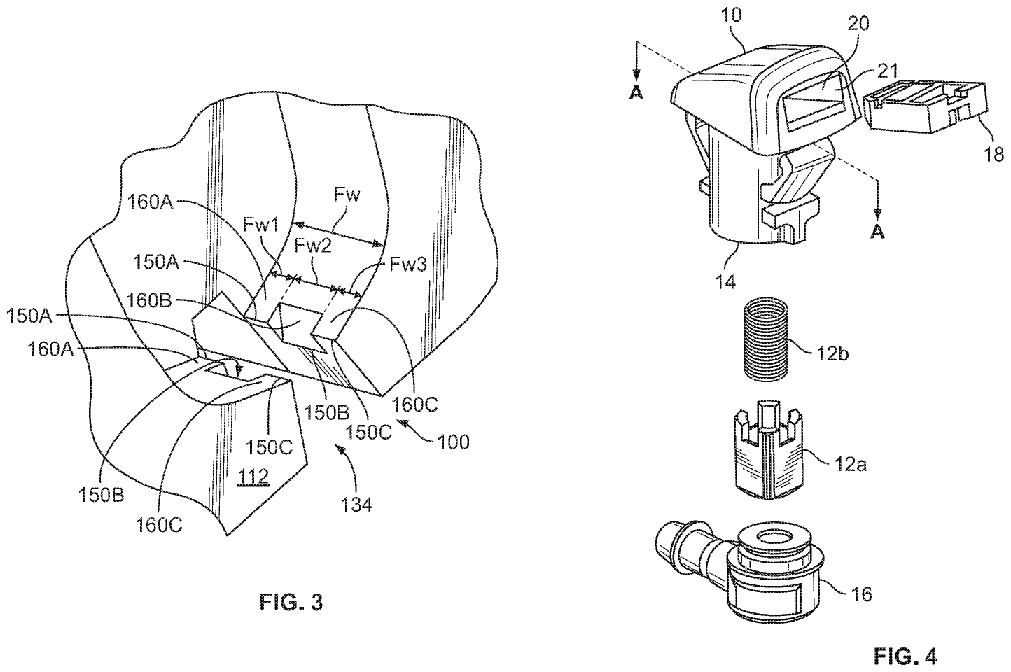

There are additional spray geometries available that are difficult to produce with traditional injection molding processes. One example is a multiple shut-off or multi-lip shear nozzle. A flow geometry of this style is taught in prior art U.S. Pat. No. 10,493,470 and is illustrated in FIG. 3 which is incorporated by reference herein in its entirety. Furthermore, true 3D converging-diverging nozzles, as well as hemispherical shear geometries, pose manufacturing inefficiencies using traditional methods such as molding.

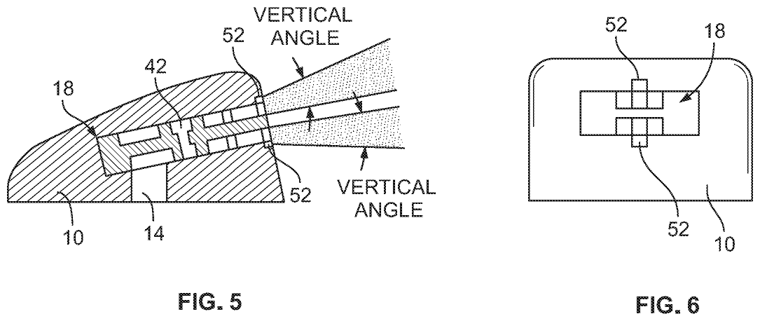

Returning to fluidic nozzle designs, U.S. Pat. No. 7,014,131, which is incorporated by reference herein in its entirety, teaches a nozzle assembly, typical to front windshield cleaning, with a housing, insert (fluidic oscillator such as those shown by FIGS. 1 and 2), and other parts to achieve the desired features of the final product. See FIG. 4. Here we can see that the nozzle housing has a slot substantially rectangular in shape, configured to receive an insert, such as a fluidic oscillator insert, though other configurations are available. The substantially rectangular shape benefits the design of assembly equipment and its primarily linear motions during assembly operations. The insert containing the fluidic geometry shown by such patents as U.S. Pat. No. 6,497,375, which is incorporated by reference herein in its entirety, is shown positioned in front of the housing slot. In the final completed assembly, the insert will be pushed into the slot until it is substantially flush with the front face of the housing. The geometry on this insert can be on both sides of the chip depending on the needs of the application. FIG. 5 illustrates a cross-section of an assembled housing 10 having a significant number of interconnected fluid passageways by inserting the fluidic insert 18 within the cavity defined by the housing 10. The resulting assembly includes passageways 42 that interconnect an inlet 14 to receive fluid or air and outlets 52 to spray fluid in a desired pattern therefrom. The fluidic insert 18 is manufactured separately from the nozzle housing 10 by molding and when assembled becomes die-locked within the cavity. FIG. 6 illustrates the assembled housing 10 of FIG. 5 from the front view that illustrates the narrowness of the resultant outlets 52 and how the perimeter of the passageways are defined by the body of the insert 18 and the inner surface of the cavity defined by the housing 10.

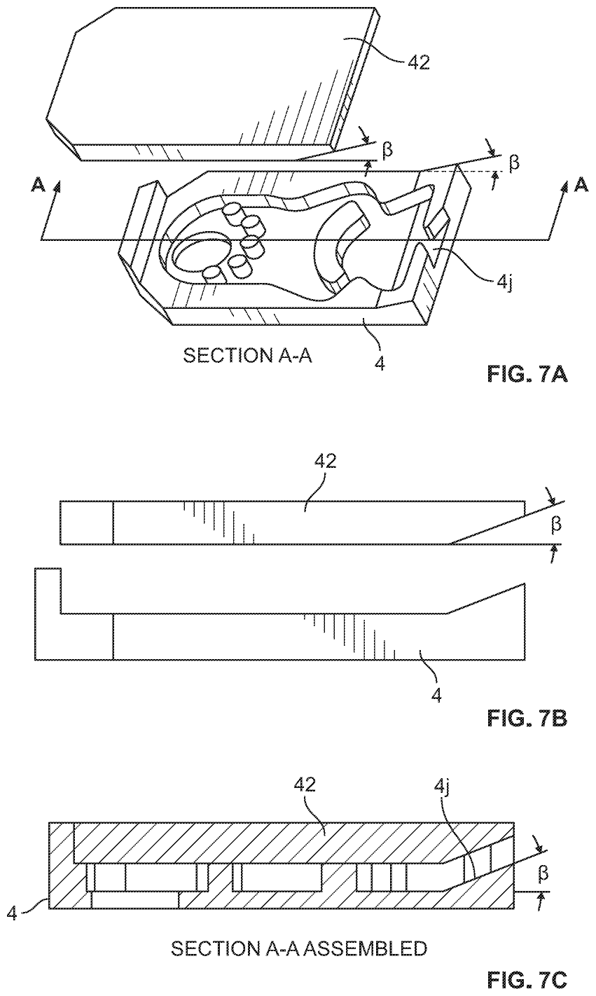

Due to the limitations of the injection molding tool construction, a limited amount of “aim” is possible, due to the need to insert or slide the chip in the cavity of the housing and the resulting parting line constraints. Additional spray aim can be achieved in the chip itself through floor tapers and end effecters, but only to a minor extent. Large aims are sometimes desirable and U.S. Pat. No. 7,677,480 is incorporated by reference herein in its entirety and teaches a method to achieve this, but ultimately results in more molded pieces and extra assembly steps. An example of this method is shown in FIGS. 7A, 7B, and 7C.

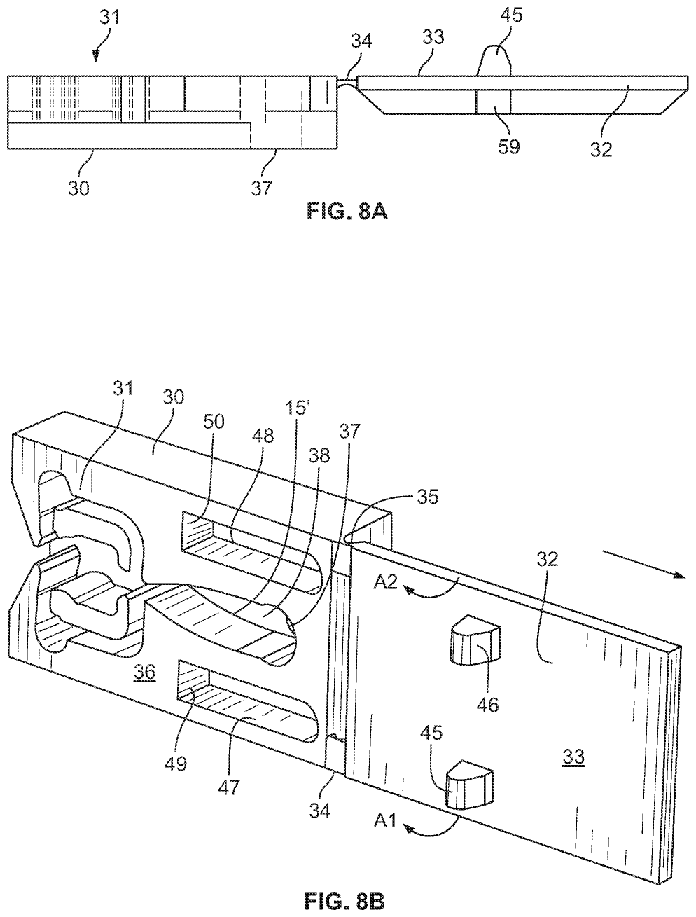

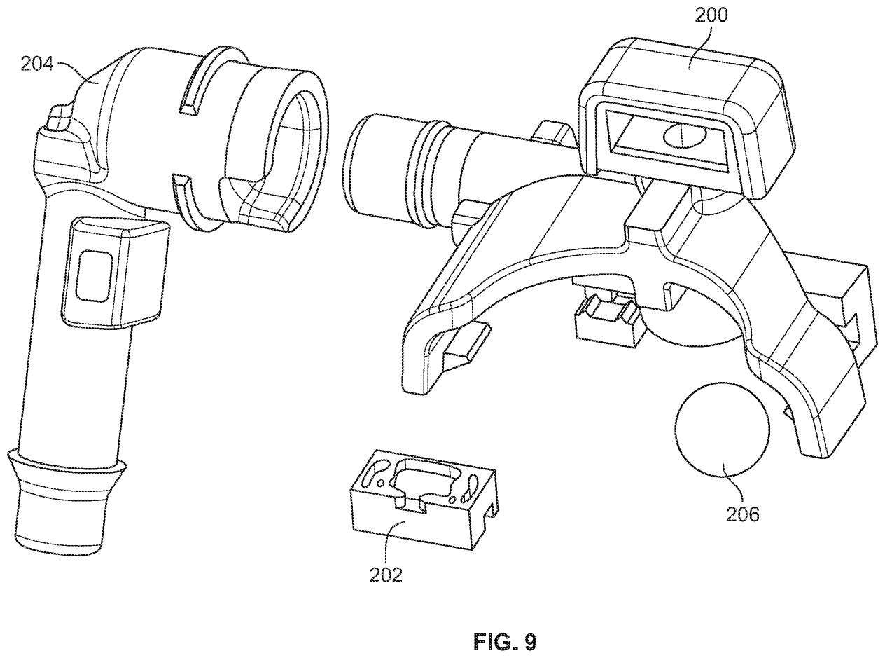

Practitioners of this insert-in-slot method understand some subtle challenges with injection molded parts. Non-uniform wall thicknesses can result in “sinks”. Stylistic considerations and tooling design constraints can often contribute to this issue. When the resultant sinks are manifested in the slot, there can be difficulty in totally sealing the flow passages of the final assembly that results in degraded performance. There are other methods to help solve this sink issue and are taught in U.S. Pat. No. 5,845,845 which is incorporated by reference in its entirety. The '845 patent discloses the use of an additional, uniform wall sink-free lid to create a sealing surface prior to installing the geometry into the housing. An example of this can be seen in FIGS. 8A and 8B.

Further, FIG. 9 illustrates an embodiment of a vehicle nozzle spray assembly having four separate components including a nozzle housing 200, an insert 202, an elbow 204, and a sealing ball 206. The complexity of this assembly is high in order to get the required attributes with the limitations of injection molded design.

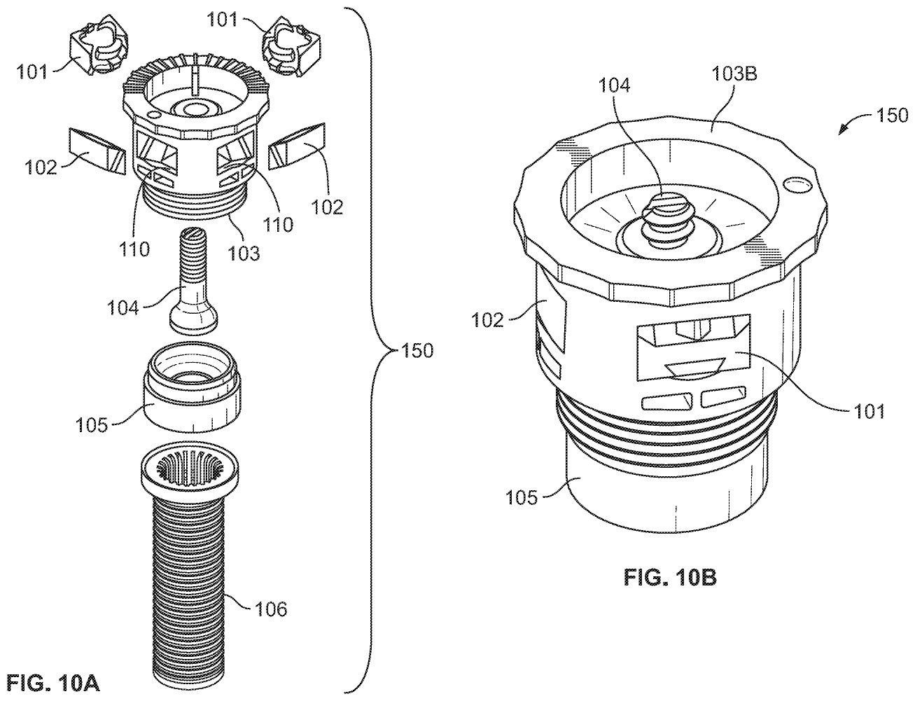

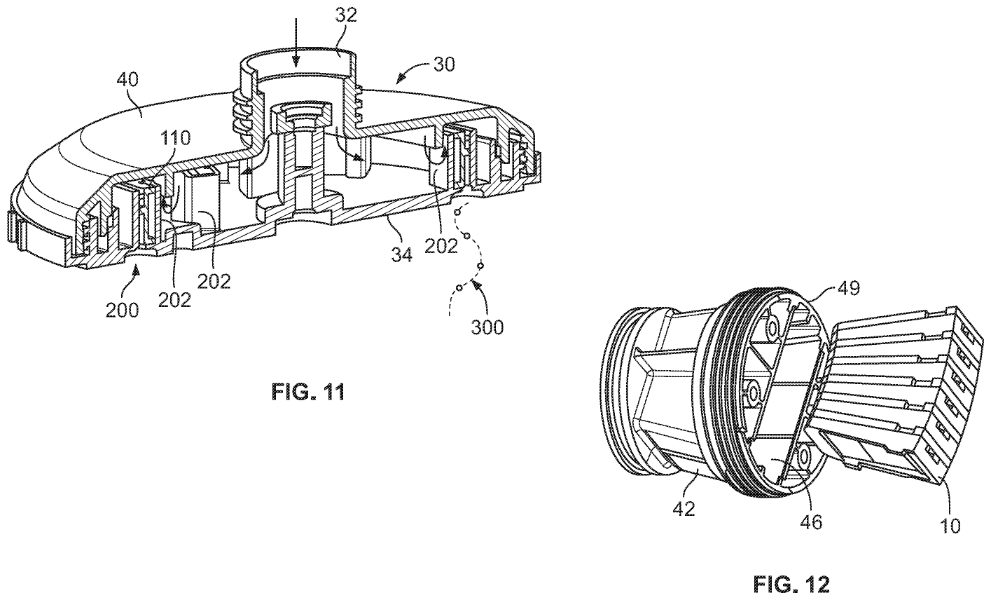

It should also be noted that the traditional nozzle design shown in FIG. 4 is not considered stylistically appealing and has resulted in the migration of the nozzles from the hood of the vehicle to other locations, such as the air inlet panel or cowl or under the hood edge. These styling demands have driven systems and nozzle locations that have less effective cleaning, compromising the best performance achievable. It is worth noting that this style of assembly has been adopted in many other product areas and is not limited to automotive products. For example, it is used in the irrigation industry for popup spray heads, as taught in U.S. Pat. No. 9,987,639 which is incorporated herein in its entirety, and as illustrated by FIG. 10. Further, shower head and body spray applications may incorporate fluidic inserts manufactured separately from the outer housing therefrom such as in FIGS. 11 and 12, as taught in U.S. Pat. Nos. 10,086,388 and 7,111,800 which are incorporated herein in their entirety.

As the transportation market has evolved and the product designs have become more complicated, the need for different packaging and manufacturing methods are needed. With the passage of the Cameron Gulbransen Kids Transportation Safety Act of 2007, which mandates an improved rearward field of view in vehicles of a gross vehicle weight of 10,000 lbs or less, the need for more innovative solutions is required. An extremely popular and effective method of meeting the requirements of this act is to add a rear facing camera to the vehicle. When the vehicle is placed in reverse, the camera is activated, and the video feed is sent to the in-dash display, allowing the driver to get a clear, unobstructed view of the rear of the vehicle, before completing any maneuvers. This system is highly effective until the camera becomes occluded with debris, with some vehicle geometries being more prone to getting dirty than others. Once occluded, the vehicle operator is forced to clean the camera to restore functionality or ignore and eliminate the functionality, increasing the danger of a back-over incident and effectively bypassing the law's intended effect.

Similarly, the rise of Autonomous Vehicle (“AV”) concepts has increased the demand for all types of sensor cleanings. Such sensors can include: cameras, infrared, proximity, and LIDAR, to name a few. They are also typically less effective when occluded with debris. Seeing this as a challenge, many vehicle manufacturers have added a multitude of sensor cleaning options to the vehicle, allowing the operator to clean an exterior facing camera, on-demand from the comfort of the crew compartment. In one embodiment, an on-board computer system decides when cleaning is necessary and triggers an independent cleaning event. The architecture of these sensor cleaning implementations is similar to cleaning a windshield, with several important distinctions. The first is that there is no mechanical cleaning of the surface in the form of a wiper arm. An even distribution of the cleaning fluid is now a higher priority due to the lack of mechanical cleaning/distribution afforded by a wiper on a windshield application. The second is the area to be cleaned on such a sensor is orders of magnitude smaller than a windshield. A result of this reality is that significantly less cleaning fluid is required. A typical windshield cleaning nozzle flows nearly 1000 mL/min, while a comparable sensor cleaning nozzle is less than 300 mL/min typically. Additionally, packaging becomes a significant challenge as imbedded sensors are in tight areas and with the case of optical sensors, the nozzle cannot be in the view of the sensor, or degraded sensor performance will result.

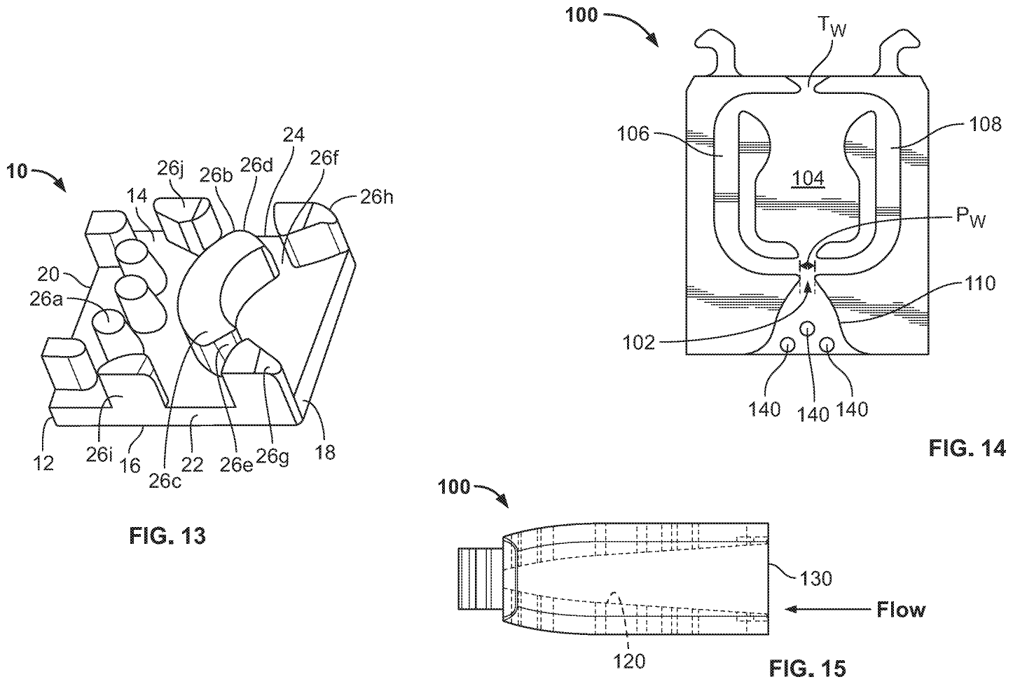

U.S. Patent Publications 2014/0060582 and US 2017/0036650, and U.S. Pat. No. 9,992,388 are incorporated by reference in their entireties and illustrate various methods for solving those goals. However, some challenges have arisen as the realities of these tight packages and non-standard vehicle volumes are realized. For example, in driving down the package size of the nozzle housing and fluidic insert assemblies discussed above, the ability to make a nozzle smaller becomes hampered by some realities of manufacturing. For example, FIG. 13 illustrates a wall-less fluidic chip that is an attempt to make the insert as small as possible, by removing the plastic on the side of the chip and letting the walls that define the cavity within the nozzle housing complete the flow paths as disclosed by U.S. Pat. No. 8,662,421 which is incorporated by reference in its entirety. As a result, the structural integrity of the insert is lessened, as well as the available flat area on the face of the insert, which may increase the risk of damage during assembly with the nozzle housing. Additionally, the part becomes difficult to manually handle as well as error proof for assembly. Another challenge of this compromised structural integrity can be the reduction of interference between the housing and the insert. The insert is now more susceptible to freeze-thaw push out of the insert from the housing. Some existing nozzle solutions also tend to run at higher pressures than traditional washer nozzles and this reduced interference can result in the insert being ejected from the housing.

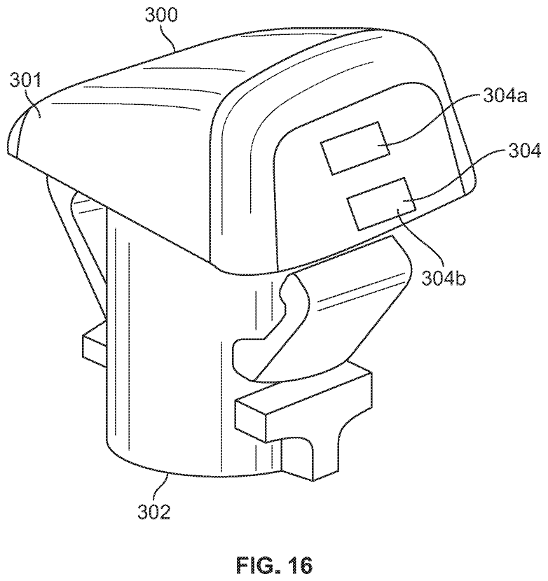

One popular solution for cleaning wide width and height sensors is to use a circuit style taught by U.S. Pat. No. 8,702,020 which is incorporated by reference in its entirety and discloses one or more types of previously discussed fluidic geometries and introduces a tapered chip. Here, two separate sprays may be produced and intersect shortly after exiting the outlet, an example of which is shown in FIGS. 14 and 15. Because this insert is tapered, it is typically implemented in at least a three piece assembly to ensure that the insert does not “walk” or is not forced out of the nozzle assembly due to some of the conditions mentioned above.

Finally, debris from within the cleaning system may also be a concern. The insert in FIGS. 13 and 14 illustrates a filter arrangement where the filter pins are made in the direction of the pull. This may make the circuit longer, adding burden to the packaging space challenge. This type of filter arrangement is taught in U.S. Pat. No. 6,186,409Error! Bookmark not defined. and Published Patent No. US2018/0070952 which are incorporated by reference herein in their entireties.

Moreover, as alluded to in the production volume statement above, the vehicle manufacturers desire a low cost of standard injection molding tooling which is not practical for low volume production parts. It is desirable to be able to produce a high quality, traditionally hard-tooled molded part to achieve the functionality of the final assembly. Another challenge for the AV implementation is that it is a rapidly evolving product type and engineering changes are occurring at a significantly higher rate than more traditional models.

These issues have been addressed by applicants by introducing a new manufacturing method for nozzle housings and fluidic oscillator chips. Over the last two decades, Rapid Prototyping or Additive Manufacturing has improved to the point where some of the methods and materials can now be considered for volume production. Several manufacturers have started to utilize Additive Manufacturing (AM) for production such as disclosed by U.S. Pat. No. 9,844,912 incorporated herein by reference. The reality of AM advances has caused a reconsideration of manufacturing strategy. It is now possible to integrate the now die-locked flow passages, described above, within the housing itself. This solution eliminates the two-piece design, the handling issue, and any installation of insert to housing issues that may have existed. Additionally, the designer can now realize a savings on packaging space, as he or she no longer needs to preserve space needed for plastic to make the parts rigid enough to handle and install by press fit methods, as well as the opportunity to design filters that better fit in the package space. The research scientist can now consider flow passage geometry that was impossible with normal line-of-draw restrictions of injection molding. Perhaps new distributions are realizable. Styling could now integrate a “cool” looking nozzle design, not achievable with traditional manufacturing methods, as a show piece and move the nozzle back to the hood, where best cleaning performance is realized.

As you can see in Figure, a cross-section of the completed assembly, there are a significant number of now completed fluid passageways. It is important to note that these passageways are formed by the insert or chip and completed by the perimeter surface of the cavity. As inserted, these fluid passageways are now die-locked and are not able to be manufactured correctly if attempted through injection molding. FIG. 6 shows the now completed assembly from the front, illustrating the narrowness of the resultant final assembled openings for spraying fluid in a desired spray pattern. The tortuous fluid pattern is complete with the surface of the inner cavity of the housing along with the pattern on the insert. This configuration has been identified to produce an oscillating spray pattern in a manner that conserves fluid and generates a desired pattern. The actual geometry of the tortuous fluid pattern has been highly researched to enable the facilitation of such an oscillating spray pattern.

The instant application is directed to disclosing a method for creating a nozzle or device using additive manufacturing techniques wherein such nozzle or device is configured to generate an shear type spray or an oscillating spray pattern made from a generally continuous monolithic material with a die-locked tortuous fluid path or pattern located within a nozzle housing between a fluid inlet and a fluid outlet. FIGS. 1-15 are provided to illustrate various contemplated embodiments of die-lock tortuous fluid passage patterns that are contemplated to be used in the monolithic nozzle device of the instant disclosure. The monolithic or continuous nozzle device contemplated includes fluid passageways having a “die-locked tortuous fluid pattern” that is formed integrally to the nozzle device.

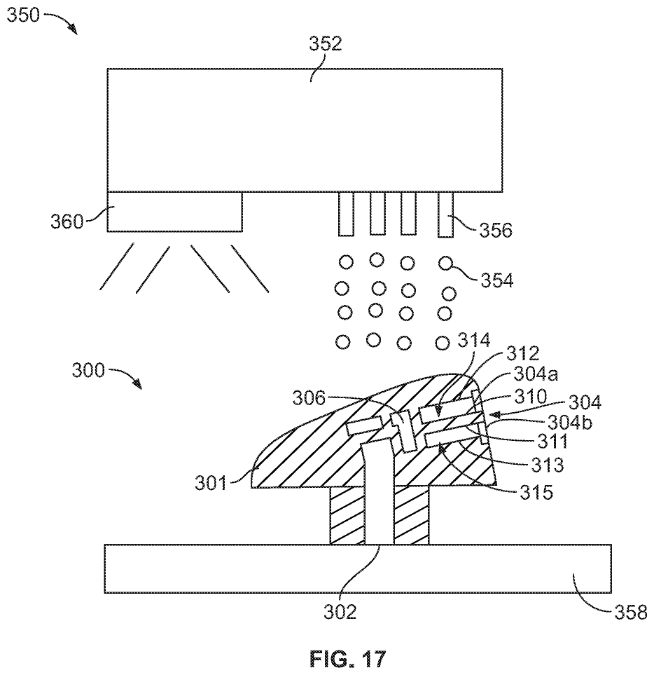

FIG. 16 illustrates a nozzle 300 that includes a die-locked tortuous fluid pattern 306 therein along a portion of a housing 301 between a fluid inlet 302 and a fluid outlet 304. Further, FIG. 17 illustrates an additive manufacturing system for manufacturing the nozzle 300 showing the cross section of the nozzle 300 (as compared to FIG. 5) an including the die-locked tortuous fluid path 306 located within the nozzle head between the inlet 302 and outlet 304. The production floor and vehicle manufacturers can realize a significant advantage. The difficulty of molding “sink” free parts may be reduced resulting in more dimensionally stable parts. The vehicle manufacturers and the production floor can now implement design changes with significantly greater rapidity as no steel changes need to be made, just loading a new design into the machine.

The use of additive manufacturing allows for the manufacture of a nozzle device that includes a housing having an inlet 302 for receiving fluid and an outlet for spraying fluid in a predetermined and desirable shape and trajectory. The inlet 302 is configured to be attached to a source of fluid and the outlet 304 is configured to dispense or spray a patterned fluid spray to atmosphere or directionally towards a surface at a predefined distance therefrom. Between the inlet 302 and outlet 304 includes a fluidic geometry that includes a die-locked tortuous fluid path 306 having integrated flow passages manufactured by additive manufacturing technologies. This eliminates at least two tools to be purchased as well as the assembly steps utilized in conventional manufacturing such as molding. The die-locked tortuous fluid path may include a fluidic oscillator geometry such as those illustrated by FIGS. 1-15 therein resulting in smaller size assembly that eliminates the need for excess plastic material along the housing or the need for a press fit assembly.

In an embodiment, disclosed is a method of making a nozzle device that includes at least one die-locked tortuous flow passage between an inlet and an outlet such that fluid is configured to exit the outlet in a predetermined flow rate, angle, or pattern. In another embodiment, provided is a generally continuous monolithic nozzle device that includes a cavity or die-locked tortuous fluid path shaped to define a fluidic geometry that includes at least one floor surface, a ceiling surface, and a plurality of walls shaped in a fluidic oscillator geometry. The fluidic oscillator geometry includes at least at least one interaction chamber and at least one power nozzle configured to process a flow of fluid and distribute a spray of fluid in an oscillating manner. In an embodiment, the floor surface, ceiling surface and plurality of walls define a single cavity that includes aggressive texturing or shapes not formable by injection molding. The generally continuous nozzle device is formed by additive manufacturing. Generally continuous and/or monolithic herein refers to a single piece of material that may be made with additive manufacturing techniques.

FIG. 17 illustrates a cross sectional view of a fluidic geometry that include an die-locked tortuous flow passage having a dual sided fluidic oscillator geometry. This geometry includes an upper floor surface 310, a lower floor surface 311, an upper ceiling surface 312 and a lower ceiling surface 313. An upper interaction chamber 314 is positioned above a lower interaction chamber 315 and are each in fluid communication with at least one power nozzle (not shown) to receive pressurized fluid therein and an opposite upper outlet 304a and lower outlet 304b configured to distribute a spray of fluid in an oscillating manner from both upper and lower outlets.

In one embodiment, provided is a continuous nozzle device that includes a fluidic geometry between the inlet and outlet wherein the nozzle device includes at least one of a die-locked mounting feature, a fluidic geometry that includes a hemispherical shear geometry, a fluidic geometry that includes a multi-lip shear geometry, a fluidic geometry that generates a plurality of sprays wherein the plurality of sprays may include 3 dimensional converging or diverging patterns.

One embodiment contemplates a continuous nozzle device having an outlet configured to form extreme aimed sprays, where traditional injection molded slides are not possible. One embodiment contemplates a continuous nozzle device having a fluidic geometry that includes die-locked filter implementations to reduce package size. Another embodiment contemplates a continuous nozzle assembly having a fluidic geometry that includes integrated elastomeric sealing pads, eliminating pad housing assembly or two shot molding complexity. Another embodiment contemplates a continuous nozzle device having a fluidic geometry that is configured to generate a three-dimensional distribution patterned spray such as in an X pattern.

Another embodiment contemplates a continuous nozzle device having a fluidic geometry that includes a heating element contained within the housing, wherein the heating element (not shown) may be more closely located to the fluidic geometry resulting in a more efficiently heated nozzle, as it is closer to the flow passages.

One embodiment contemplates a continuous nozzle device having a fluidic geometry that includes radical stylings of dome, outside of IM as a design or styling feature. In each of the described embodiments, the resulting nozzle device may be configured as a shear type spray or as an oscillating type spray and this disclosure is not limited. This disclosure contemplates that additive manufacturing techniques may be utilized to create a nozzle having die-locked tortuous fluid paths having any of the disclosed geometries from the chips or inserts of FIGS. 1-15 herein.

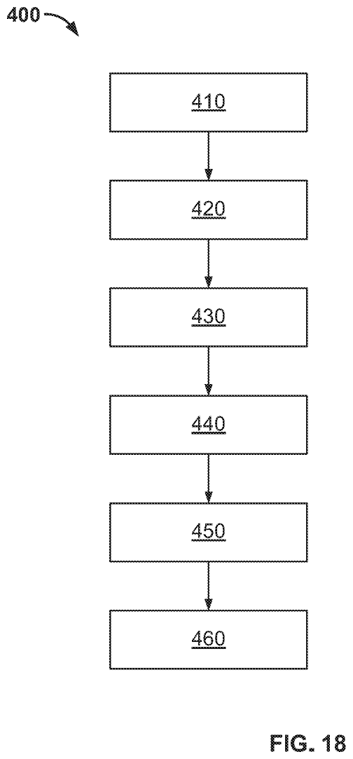

Referring to FIGS. 17 and 18, illustrated is a system and method 400 for producing a device such as a nozzle having a die-locked tortuous fluid path defined therein. An additive manufacturing machine 350 such as a liquid photopolymer type additive manufacturing machine may be provided for use in this method. The machine 350 may include a reservoir 352 for storing a liquid material 354, at least one dispenser 356 in fluid communication with the reservoir and a platform 356 for supporting the emitted material thereon. The machine can be a photopolymer type additive manufacturing machine. The dispensers 356 may dispense a plurality of streams of material 354 and be configured to move or adjust to dispense such material in a desired pattern to form various layers into the nozzle device 300. Alternatively, or in addition, the platform 358 may be configured to move or adjust the position of the nozzle device 300 to receive the dispensed material in the desired pattern to form the instant layer of material. The machine 350 may be automatically controlled by a controller and may be configured to manufacture a plurality of nozzle devices at the same time.

The machine 350 may include one or more lights 360 which serve to emit light onto the layered material after its patterned deposition. The lights 360 may be UV lights or lasers configured to cure the dispensed material as it is arranged in layers and patterns. The dispensing, layering, and curing may be repeated many times until the nozzle device is fully formed.

The method of manufacturing a monolithic nozzle device 400 configured to spray a fluid spray having a predetermined flow rate, angle, or pattern includes, e.g., in block 410, providing an additive manufacturing machine. In block 420, selecting a material and a design communicated or otherwise input to the machine 350 and associated controller. The machine may, e.g., in block 430, deposit, from at least one dispenser head, a layer of material onto the platform in a pattern. The initial layer of material may be cured by applying UV light thereto. Subsequently, the dispenser head 356 or the platform 358 may be adjusted or moved to account for the deposition of material to form a subsequent layer of material, step 440. Subsequent layers of material and adjustments to the dispenser head or platform may be made upon each subsequent layer until the nozzle device is formed, step 450. The nozzle device may be cured continuously through formation of each of the subsequent layers and patterns or as the dispensing of material in the desired patterned layers occurs. This may be performed by applying a light to the plurality of layers to bond the plurality of layers together thereby creating detailed patterns that, when bonded, form layered portions of a die-locked tortuous fluid path located within a housing perimeter or outer surface of material. The light may be a UV light or laser light that is designed to interact with dispensed photopolymer materials. Once cured, the nozzle device 300 includes at least one die-locked tortuous fluid passage 306 positioned between an inlet and an outlet such that fluid is configured to enter the inlet, wherein the die-locked tortuous fluid passage is configured to modify the pressure profile of the fluid passing therethrough such the fluid may exit the outlet having a predetermined flow rate, angle, or pattern, step 460. The nozzle device may be removed from the platform.

The die-locked tortuous flow passage may be formed to include a at least one floor surface, at least one ceiling surface, and a plurality of walls that define an interaction chamber in communication with at least one power nozzle and the outlet. This configuration may form a fluidic oscillator geometry as disclosed by FIGS. 1, 2, 4, 5, and 7-15. The nozzle device may include a rain can style showerhead, a vehicular spray nozzle for windshields, headlights, or sensors, or an irrigation sprinkler head. Further, the die-locked tortuous fluid passage and the outlet may be configured to spray a shear type spray or an oscillating type spray.

Various types of materials are contemplated to be used in this manufacturing process including plastics, thermoplastic resin fiber, nylon polycarbonate, and variations of these materials configured to be formed to allow for fluidic behavior through such fluid passages. In certain embodiments, the material can be selected to include a powder. The powder can include at least one of a metal powder, an alloy powder, a composite powder, or a ceramic powder. It is contemplated that the material can include a non-powder or any other suitable material. The material can be selected to have a desired porosity, grain size, molecular structure, and/or any other suitable characteristic that affects the final formation of the fluid channels therein. The material may be a three-dimensional printable liquid photo-polymeric material and the type of material may preferably based on the size of the nozzle device. Smaller nozzle devices preferably include fine material while a larger nozzle device could support relatively coarser material. For example, a nozzle device that is under about 3″ in size it is preferable to use a material having a resolution range that is below about 50 microns and for nozzle device that is between about 3″ to about 10″ in size it is preferable to use a material having a resolution range that is greater than about 100 microns. In an embodiment, such a range for the larger sized nozzle device may include a resolution range that is less than 1000 microns. These ranges of coarseness relative to nozzle device size has been found to provide sufficient accuracy when manufacturing or forming the die-locked tortuous patterns within the nozzle device using additive manufacturing steps as described herein.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

Having thus described the invention, I claim:

1. A method of manufacturing a monolithic nozzle device configured to spray a fluid spray having a predetermined flow rate, angle, or pattern comprising:
depositing, from at least one dispenser head, a layer of material onto a platform having a pattern configured to allow fluid flow through at least one die-locked tortuous fluid passage;
adjusting the dispenser head or platform;
depositing subsequent layers of material onto said prior layers of material on said platform having a common pattern configured to allow fluid to flow through said at least one die-locked tortuous fluid passage, and adjusting the dispenser head or platform upon each layer until the nozzle device is formed;
curing the nozzle device by applying a light to the plurality of layers to bond the plurality of layers together, and once cured, the nozzle device includes the at least one die-locked tortuous fluid passage positioned between an inlet and an outlet such that fluid is configured to enter the inlet, pass through the die-locked tortuous fluid passage, and exit the outlet;
wherein the die-locked tortuous fluid passage is configured to modify a pressure profile of the fluid passing therethrough, such that the fluid is configured to exit the outlet having a predetermined flow rate, angle, or pattern; and
removing the nozzle from the platform.

2. The method of claim 1 wherein said die-locked tortuous flow passage includes at least one floor surface, at least one ceiling surface, and a plurality of walls that define an interaction chamber in communication with at least one power nozzle and the outlet.

3. The method of claim 1 wherein said material is a three-dimensional printable liquid photo-polymeric material.

4. The method of claim 1 wherein said material includes a resolution that is less than 50 microns.

5. The method of claim 1 wherein said material includes a resolution range based on the size of said nozzle device including:
for a nozzle device that includes a size that is under about 3 inches, the material includes a resolution range that is below about 50 microns; and
for a nozzle device that includes a size that is between about 3 inches to about 10 inches, the material includes a resolution range that is greater than about 100 microns and less than 1000 microns.

6. The method of claim 1 wherein the step of depositing a layer of material onto a platform further comprises depositing a plurality of layers of material onto the platform to form a plurality of nozzle devices.

7. The method of claim 1 wherein the step of curing the nozzle includes applying a UV light or laser to the plurality of layers.

8. The method of claim 1 wherein the die-locked tortuous fluid passage and the outlet are configured to spray a shear type spray or an oscillating type spray.

9. A monolithic nozzle device comprising:
a nozzle head including an outer surface and a die-locked tortuous fluid passage positioned within the outer surface and is shaped to define a fluidic geometry located between an inlet and an outlet of the nozzle head;
the fluidic geometry includes a floor surface, a ceiling surface, and a plurality of walls shaped to form the fluidic geometry wherein the die-locked tortuous fluid passage is configured to modify a pressure profile of the fluid passing therethrough such that said fluid is configured to exit the outlet having a predetermined flow rate, angle, or pattern;
wherein the die-locked tortuous fluid passage is monolithically formed within the nozzle head.

10. The monolithic nozzle device of claim 9, wherein the fluidic geometry includes at least one interaction chamber and at least one power nozzle configured to increase the pressure of a flow of fluid and distribute said flow of fluid to the interaction chamber to be dispensed from the outlet in an oscillating manner.

11. The monolithic nozzle device of claim 9, wherein the floor surface, ceiling surface and plurality of walls define a single cavity that includes aggressive texturing or shapes not formable by injection molding.

12. The monolithic nozzle device of claim 9, wherein the fluidic geometry comprises:
a dual sided fluidic oscillator geometry that includes:
an upper floor surface, a lower floor surface, an upper ceiling surface and a lower ceiling surface; and
an upper interaction chamber positioned above a lower interaction chamber, wherein each interaction chamber is in fluid communication with at least one power nozzle and an opposite upper outlet and lower outlet configured to distribute a spray of fluid in an oscillating manner from both upper and lower outlets.

13. The monolithic nozzle device of claim 12, wherein the nozzle device includes an angled outlet that is configured to generate a plurality of sprays, wherein the plurality of sprays include 3 dimensional converging or diverging patterns.

14. The monolithic nozzle device of claim 9, wherein the fluidic geometry includes at least one of a hemispherical shear geometry, a multi-lip shear geometry, and a plurality of die-locked filter posts.

15. The monolithic nozzle device of claim 9, wherein the fluidic geometry is configured to generate a three-dimensional distribution patterned spray having an X-shaped pattern.

16. The monolithic nozzle device of claim 9, wherein the fluidic geometry is configured to generate a shear type spray or an oscillating type spray from the outlet.

17. A method of manufacturing a plurality of monolithic nozzle devices, each configured to spray a fluid spray having a predetermined flow rate, angle, or pattern comprising:
depositing, from a plurality of dispenser heads, a plurality of layers of material onto a platform, each having a pattern configured to allow fluid flow through at least one die-locked tortuous fluid passage;
adjusting the plurality of dispenser heads or platform;
depositing subsequent layers of material onto said prior layers of material on said platform having a continuous pattern with the prior layers of material that is configured to allow fluid to flow through said at least one die-locked tortuous fluid passage and adjusting the plurality of dispenser heads or platform upon each layer until the nozzle device is formed;
curing the nozzle device by applying a light to each of the plurality of layers to bond the plurality of layers together, and once cured, each of the plurality of nozzle devices include the at least one die-locked tortuous fluid passage positioned between an inlet and an outlet, such that fluid is configured to enter the inlet, pass through the die-locked tortuous fluid passage, and exit the outlet;
wherein the die-locked tortuous fluid passage of the plurality of nozzle heads are configured to modify a pressure profile of the fluid passing therethrough, such that the fluid is configured to exit the outlet having a predetermined flow rate, angle, or pattern; and
removing the plurality of nozzles from the platform.

18. The method of claim 17, wherein said die-locked tortuous flow passage includes at least one floor surface, at least one ceiling surface, and a plurality of walls that define an interaction chamber in communication with at least one power nozzle and the outlet.

19. The method of claim 17, wherein said material includes a resolution range based on the size of said nozzle device including:
for a nozzle device that includes a size that is under about 3 inches, the material includes a resolution range that is below about 50 microns; and
for a nozzle device that includes a size that is between about 3 inches to about 10 inches, the material includes a resolution range that is greater than about 100 microns and less than 1000 microns.

20. The method of claim 17, wherein the die-locked tortuous fluid passage and the outlet are configured to spray a shear type spray or an oscillating type spray.
